(19) United States
(12) Patent Application Publication
(10) Pub. No.: US 2011/0309733 A1
(43) Pub. Date: Dec. 22, 2011

(54) Electrical lamp having an outer bulb

(75) Inventors: Lambert Frye, Steinheim (DE); Claus Pfaller, Walting-Inching (DE)

(73) Assignee: OSRAM GESELLSCHAFT MIT BESCHRAENKTER HAFTUNG, Muenchen (DE)

(21) Appl. No.: 13/148,666

(22) PCT Filed: Mar. 11, 2010
(86) PCT No.: PCT/EP10/53109

§ 371 Date: Aug. 10, 2011

(30) Foreign Application Priority Data
Apr. 2, 2009 (DE) 102009015895.2

(51) Int. Cl. H01J 61/34; H01J 9/00

(52) U.S. Cl. 313/17; 445/43

(57) ABSTRACT

An electrical lamp having an elongate inner bulb made of silica glass is provided. The electrical lamp may include a central part which is closed at two sides by fusings to which externally tubular extensions adjoin, the fusings containing foils, and the inner bulb having a longitudinal axis and an illuminant being accommodated in the inner bulb, and the inner bulb being surrounded by an outer bulb made of silica glass, wherein at the level of the end of the foils the fusings have beads which protrude radially outwards, an end region respectively of the outer bulb being connected to the bead, so heat is dissipated from the foil.

### TECHNICAL FIELD

The invention starts from an electrical lamp having an outer bulb according to the preamble of claim 1. Lamps of this kind are in particular high-pressure discharge lamps or tungsten-halogen lamps.

### PRIOR ART

EP-A 1 492 146 describes a high-pressure discharge lamp having an outer bulb in which an outer bulb is provided on an inner bulb. In particular the outer bulb is secured to a tubular extension of a seal of the inner bulb.

### DESCRIPTION OF THE INVENTION

The object of the present invention is to provide an electrical lamp having an outer bulb in which good heat dissipation is ensured between inner bulb and outer bulb.

This object is achieved by the characterizing features of claim 1.

Particularly advantageous embodiments can be found in the dependent claims.

Electrical lamps made of silica glass having an inner bulb and an outer bulb, in particular discharge lamps, which are closed at two sides, usually suffer from high energy losses owing to an increase in temperature, caused by the outer bulb, in the region of the side of the foil seal that is open to the free environment. The surrounding atmosphere is air here. This seal is usually a fusing or a pinch.

Previously the temperature stress has been solved by relatively long fused regions or else by significantly more complex lamp constructions, by way of example by allowing the outer bulb to drop onto the cylindrical sealing region, in particular fusing, of the inner bulb.

Good heat dissipation leads to a reduction in the end temperature of the foils and to the avoidance of oxidations of the foils in lamps having an outer bulb.

According to the invention the seal of the discharge vessel is provided with an additional bead, frequently called a pearl, and this bead is more precisely located in the region of the fusing in the vicinity of the outer end of the foil. This bead is used as a connecting point for the outer bulb and effectively dissipates the temperature.

Apart from a connection at the outer end of the seal in the region of a tubular extension of the seal, heat is removed from the region of the foil fusing by this additional connecting point. A defined additional thermal bridge is created in the process. Ultimately the end temperature of the foils is significantly reduced thereby.

This bead also has an advantageous effect during the production of such lamps. As described in principle in EP 1 492 146, the volume of the outer bulb may be evacuated and filled by way of an exhaust hole in the extension of a seal. This exhaust hole must be closed following the filling process. Previously it has been proposed that the exhaust hole be closed by allowing the end of the outer bulb to drop onto the cylindrical extension of the seal. However, high stresses are generated in the glass during this process.

The additional bead at the level of the fusing where the outer foil end sits allows an improved solution. The end of the outer bulb is now dropped onto this bead. This bead has a small connecting surface with the outer bulb compared with the large-area connection to the extension. The stresses in the glass of the outer bulb are significantly reduced owing to the small-area connection. The connection can, moreover, be produced with significantly less expenditure of energy because the surface to be connected is smaller. A larger angle between the connected components (outer bulb and burner shank) also results from this connection and this leads to improved mechanical strength.

The exhaust hole itself is no longer closed at all and instead is cut off from the volume of the outer bulb by the bead.

The outer bulb can also be connected to the inner bulb over a small area in the region of the extension. A thermal boundary also results from this construction which optionally allows the exhaust hole region to drop in a planar manner in the case of a defined boundary (equator of the bead) by way of vacuum and temperature.

The outer bulb filling can optionally be a vacuum, nitrogen (50 mbar-800 mbar), argon (50 mbar-800 mbar) or other gas mixtures or air (normal pressure, open system).

In principle the production method uses the following steps:

a) providing a tube made of silica glass as a precursor of the discharge vessel,
b) loading the tube with a respective electrode system at each end, wherein the electrode system comprises an electrode, a foil, a power supply and a base,
c) heating and shaping the tube at a first end so a central discharge volume, a fusing, which contains the foil, and a tubular extension, which contains the power supply and the base part, is formed and wherein during shaping or thereafter a radial bead is provided on the fusing at the level of the outer foil end,
d) evacuating and filling the discharge volume by way of the second end that is still open,
e) heating and shaping the tube at the second end so a fusing, which contains the foil, and a tubular extension, which contains the power supply and the base part, is also formed here and wherein during shaping or thereafter a radial bead is provided on the fusing here as well, wherein in the resulting discharge vessel an opening remains at the side of the second extension as a subsequent exhaust hole for an outer bulb,
f) fitting over a second tube, intended as a subsequent outer bulb, made of silica glass and with a larger diameter, wherein the length of the second tube is dimensioned such that the second tube covers the discharge volume, the sealing region and a certain part of the extension, in particular a region from 10 to 60% of the length of the extension, wherein the subsequent exhaust hole is, moreover, enclosed in the covered region,
g) rolling or melting or attaching the two ends of the second tube to form an outer bulb, so at least a vacuum-tight contact is produced in the region of the extension, wherein the exhaust hole is located inside the contact zone,
h) draining and optionally filling the volume extending between inner vessel and outer bulb by way of the exhaust hole and the end of the second extension that is still open,
i) allowing the ends of the outer bulb to drop onto the beads on the fusings.

To close the exhaust hole (if desired) renewed rolling can optionally be used, wherein the region to be rolled closed has advantageously already been reduced to a significantly smaller diameter in the first rolling process, or the exhaust hole may also be sealed by simple closing by means of the application of a vacuum. A further alternative is sealing by way of a laser beam or by way of plasma heating, or any other established method.

### BRIEF DESCRIPTION OF THE DRAWINGS

The invention shall be described in more detail hereinafter with reference to a plurality of exemplary embodiments. In the figures:

FIG. 1 shows a first exemplary embodiment of a metal halide lamp,

FIG. 2 shows an exemplary embodiment of a tungsten-halogen lamp,

FIG. 3 shows, highly schematized, a production method for the lamp according to FIG. 1

FIG. 4 shows the novel end of the production method,

FIG. 5 shows a detail of the region around the exhaust hole with bead and exhaust path still open,

FIG. 6 shows a detail of the region around the exhaust hole with bead and closed exhaust path.

### PREFERRED EMBODIMENT OF THE INVENTION

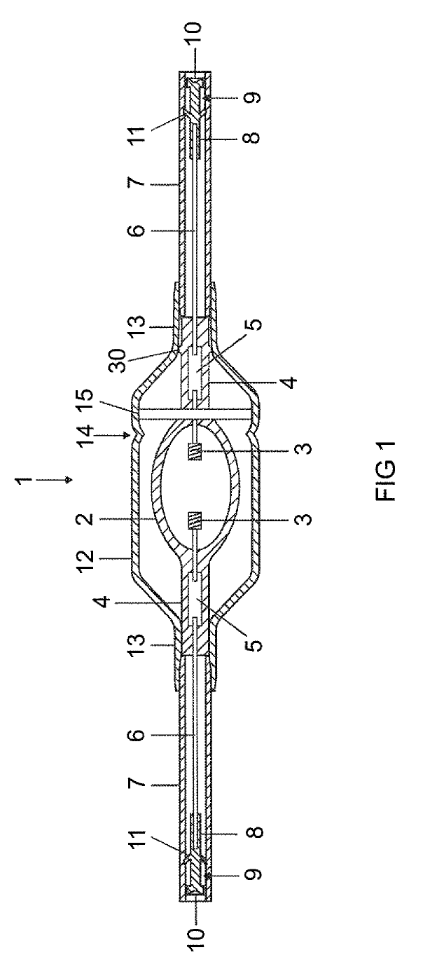

FIG. 1 shows, in a highly schematized manner, the side view of a metal halide lamp 1 that is closed at two sides. The discharge vessel 2 formed as a barrel body and made of silica glass encloses two electrodes 3 together with a metal halide filing. The bulb ends are sealed by pinches 4 or fusings in which foils 5 are embedded. These are connected to outer power supplies 6. The outer power supply 6 is guided in a tubular sleeve 7 and ends in a socket 8 of an integral base part 9. The base is manufactured in one piece from steel and also includes a circular disk 10 as a contact element and barbs 11 as centering and holding elements. The round-bodied part of the discharge vessel is surrounded by an outer bulb 12 which is rolled (13) in the region of the transition between the pinch 4 and the sleeve 7. The outer bulb 12 includes an encircling indentation 14, so a resilient support strip 15 made of stainless steel or nickel-plated iron is spread on the inner surface of the outer bulb without being able to slip sideways. The support strip contains getter materials such as Zr, Fe, V, Co. They serve to absorb different substances such as oxygen, hydrogen or the like. The outer bulb can be filled with nitrogen, another inert gas or even a vacuum.

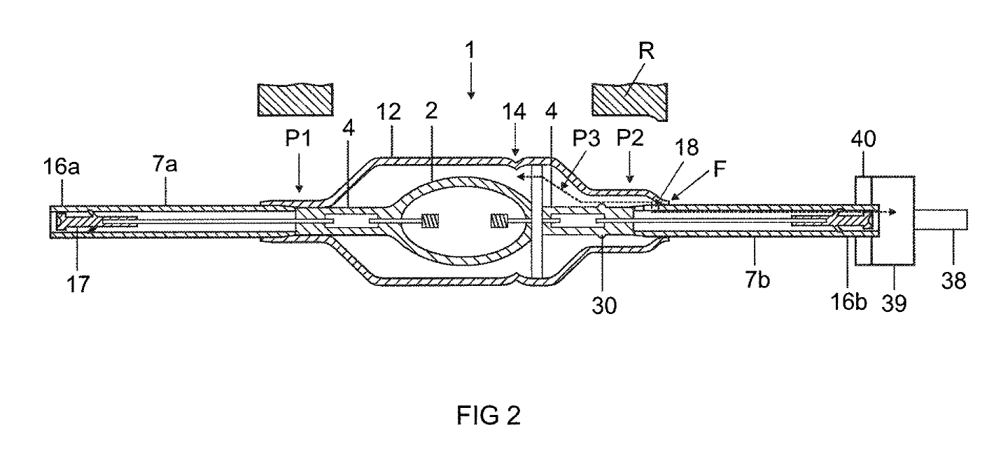

One production method will be described as follows with reference to FIG. 2: here the discharge vessel 2 is firstly finished from a cylindrical tube by means of a forming roller and possible crimping jaws which each fix, by way of example by pinching, an electrode system introduced into the tube that is still open to the extent that it is provided with a seal at both ends (pinch 4 or fusing). At the same time sleeve-like extensions 7 integrally attached to the seals remain stationary. Whereas a first extension 7a is closed in that the initially still open end 16a of the extension drops onto an introduced base part 17, an exhaust hole 18 remains open in the second extension 7b. The open end 16b is also not treated initially. The cylindrical outer bulb 12 is simultaneously pre-treated to the extent that an encircling indentation 14 laterally fixes a support strip, clamped next to it, in the outer bulb 12. The ends of the outer bulb are now rolled onto the extension 16 a,b at both sides by means of prior heating by way of flames and application of molding blocks R (arrow P1, P2) and, more precisely, such that fixing occurs outside the still open exhaust hole 18 on the second extension 16b. At the level of the exhaust hole 18 the outer bulb 12 is already rolled in but not yet such that it rests on the extension 16b (arrow P2). This arrangement is connected at the still open end of the second extension to a pump and filling system 39 by way of a supply cable 38, in particular in that a pump rubber seal 40 is placed onto the end of the extension. The base part is particularly advantageously not yet inserted here.

The atmosphere in the outer bulb can now be drained. The pumping path is shown as arrow P3. The outer bulb 12 can then be loaded with any inert atmosphere by way of this pump path or a vacuum may be retained. In the next step the exhaust hole 18 is optionally closed in that it is either rolled closed, is fused closed by means of lasers or simply closes by itself after heating and when a vacuum is applied. This is not imperative, however. The end 16b of the second extension is then “shrunk on” but only to the extent that it rests on the bead 30. The getter strip 15 can, if necessary in the case of the getter used, subsequently be activated through the outer bulb 12 by means of lasers.

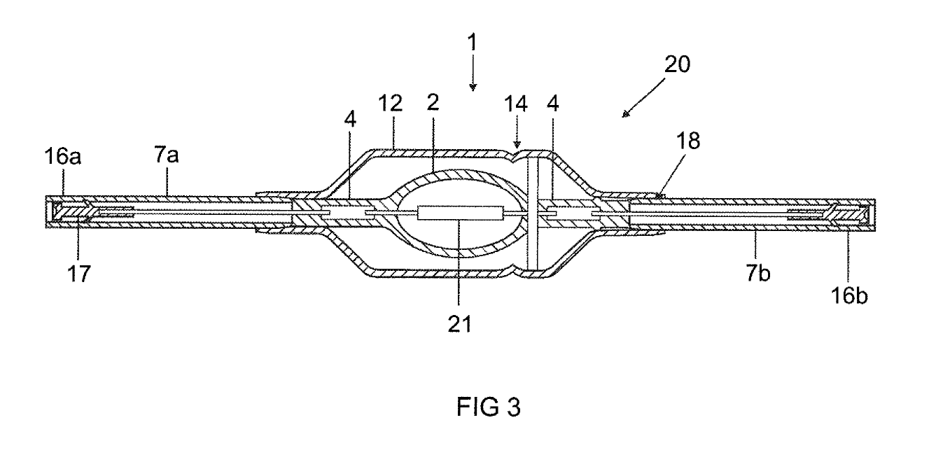

FIG. 3 shows a tungsten-halogen lamp 20 which is designed quite similarly although it does not have electrodes but an illuminant 21 inside the inner bulb.

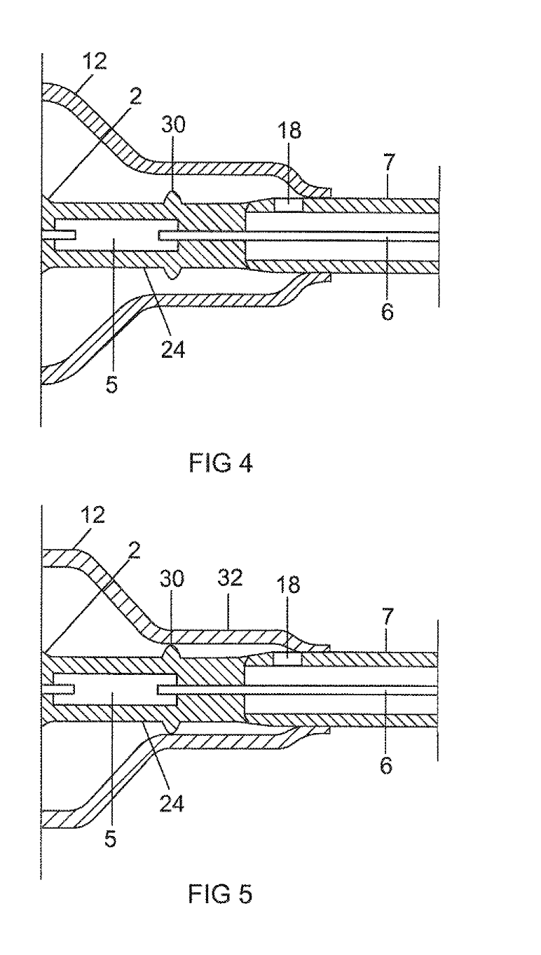

FIG. 4 shows in detail the region of the connection between inner bulb 2 and outer bulb 12. Here the glass bead 30, which, by way of example, can be produced as an encircling collar or bead by compressing, rolling or mold blowing the sealing region, sits approximately at the level of the outer end of the foil 5 in the fusing 24. Behind this and further out is located the exhaust hole 18 which creates outward of the tube-like extension 7a connection into the outer bulb 12. The outer bulb 12 is only attached at its outer end to the extension 7 of the inner bulb. The outer bulb is still spaced apart from the glass bead 30.

FIG. 5 shows that the end region of the outer bulb is then heated and the tubular narrow end 32 of the outer bulb is pressed onto the dome of the bead 30. An annular small-area connection is thus created which cuts the exhaust hole 18 off from the internal volume of the outer bulb. The exhaust hole is optionally retained as such in the process. At the same time this annular, small-area connection acts as an ideal thermal bridge between fusing 24 and outer bulb 12.

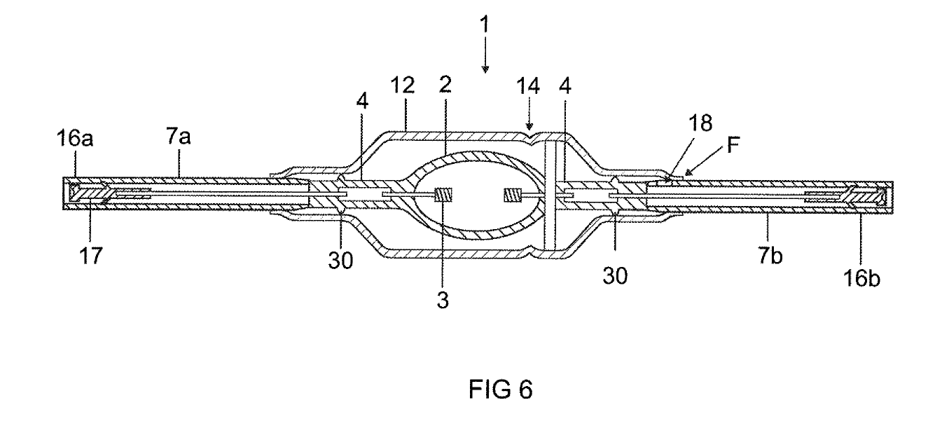

The discharge vessel 2 according to FIG. 6 has, by way of example, a filling of metal halogenides as are known per se. Two electrodes 3 are also arranged in the discharge vessel between which the discharge arc burns.

For reasons of symmetry of the thermal load both pinches 4 have beads 30 of this kind in the vicinity of the foil end in this exemplary embodiment. Only one of them has a function in connection with closing of the exhaust hole 18, however.

The shaping of the bead can be 0.4 times to multiple times the external diameter of the shank (pinch or fusing). The bead 30 is a rotationally symmetrical basic body (spherical or lens shape) which has a rounded external contour in the region with the largest diameter. The transition region to the cylinder-like shank region can be angular or rounded in shape.

1. An electrical lamp having an elongate inner bulb made of silica glass, the electrical lamp comprising:
a central part which is closed at two sides by fusings to which externally tubular extensions adjoin, the fusings containing foils, and the inner bulb having a longitudinal axis and an illuminant being accommodated in the inner bulb, and the inner bulb being surrounded by an outer bulb made of silica glass,
wherein at the level of the end of the foils the fusings have beads which protrude radially outwards, an end region respectively of the outer bulb being connected to the bead, so heat is dissipated from the foil.

2. The electrical lamp as claimed in claim 1, wherein at its end the outer bulb is also connected to the extension.

3. The electrical lamp as claimed in claim 1, wherein an exhaust hole is provided on one side in the region of the extension.

4. A method for producing an electrical lamp comprising outer bulb and comprising a discharge vessel arranged therein, the method comprising:
providing a tube made of silica glass as a precursor to the discharge vessel;
loading the tube with a respective electrode system at each end, wherein the electrode system comprises an electrode, a foil, a power supply and a base;
heating and shaping the tube at a first end so a central discharge volume, a fusing, which contains the foil, and a tubular extension, which contains the power supply and the base part, is formed and wherein during shaping or thereafter a radial bead is provided on the fusing at the level of the outer foil end;
evacuating and filling the discharge volume by way of the second end that is still open;
heating and shaping the tube at the second end so a fusing, which contains the foil, and a tubular extension, which contains the power supply and the base part, is also formed here and wherein during shaping or thereafter a radial bead is provided on the fusing here as well, wherein in the resulting discharge vessel an opening remains at the side of the second extension as a subsequent exhaust hole for an outer bulb;
fitting over a second tube, intended as a subsequent outer bulb, made of silica glass and with a larger diameter, wherein the length of the second tube is dimensioned such that the second tube covers the discharge volume, the sealing region and a certain part of the extension, wherein the subsequent exhaust hole is, moreover, enclosed in the covered region,
rolling or melting or attaching the two ends of the second tube to form an outer bulb, so at least a vacuum-tight contact is produced in the region of the extension, wherein the exhaust hole is located inside the contact zone;
evacuating and optionally filling the volume extending between inner vessel and outer bulb by way of the exhaust hole and the end of the second extension that is still open; and
allowing the ends of the outer bulb to drop onto the beads on the fusings.

5. The method as claimed in claim 4,
wherein the certain part of the extension is formed by a region from 10 to 60% of the length of the extension.

6. The method as claimed in claim 4,
filling the volume extending between inner vessel and outer bulb by way of the exhaust hole and the end of the second extension that is still open.
